(19) United States
(12) Patent Application Publication
(10) Pub. No.: US 2005/0242462 A1
(43) Pub. Date: Nov. 3, 2005

(54) Method of producing a hydraulic binder or thermoplastic containing product

(75) Inventor: Michael Windsor Symons, Pretoria (ZA)

Correspondence Address: YOUNG & THOMPSON, 745 SOUTH 23RD STREET, 2ND FLOOR, ARLINGTON, VA, 22202, US

(73) Assignee: TOWER TECHNOLOGY HOLDINGS (PTY) LTD, PRETORIA, 0184 (ZA)

(21) Appl. No.: 10/524,428

(22) PCT Filed: Aug. 14, 2003
(86) PCT No.: PCT/ZA03/00109

§ 371 Date: Feb. 15, 2005

(30) Foreign Application Priority Data
Aug. 15, 2002 (ZA) 2002/5395
Aug. 15, 2002 (ZA) 2002/5960
Aug. 15, 2002 (ZA) 2002/6532
Oct. 10, 2002 (ZA) 2002/8170

(51) Int. Cl. B29C 43/28

(52) U.S. Cl. 264/171.1; 264/259

(57) ABSTRACT

A method for manufacturing an hydraulic binder or thermoplastic binder containing product including the steps of impregnating the binder into a flexible open cell polymeric foam element by compressing the foam element to exclude air from the open cells and then releasing the compression with the foam elements whilst in contact with the binder so that the binder penetrates and becomes contained in the open cells of the foam elements as it regains its shape. Alternatively impregnating the binder into the foam element from one side under pressure so that the binder penetrates and becomes contained in the open cells of the foam and then allowing the binder to set or hardened and dry to form the product. The product is particularly suitable as a building element.

### BACKGROUND OF THE INVENTION

This invention relates to a method of producing a product from a flexible open cell polymeric foam element and a hydraulic binder slurry, and to the product so made. The product may be for example a panel or a board or the like for use in the building industry.

Portland cement based building boards are well known. They are generally made from cement bound particle board or the like, i.e they contain lignocellulosic particles or fibres. These boards however suffer from the disadvantage that the lignocellulosic particles or fibres have a propensity to swell when water wetted and can interfere with the cure of the Portland cement. In addition, the manufacture of the boards generally includes autoclaving, which is energy intensive.

Other types of hydraulic binder based building boards include those that contain expanded minerals such as vermiculite. The method of manufacture of such boards generally involves the use of pressure and temperature in a sophisticated production plant.

Another type of known boards are gypsum building boards which generally include the use of paper liners.

Thus, while many types of hydraulic binder based building boards are known, they generally suffer from one or other disadvantage. There is thus a need for a new type of hydraulic binder based product.

### SUMMARY OF THE INVENTION

According to a first aspect of the invention there is provided a method of producing a product from:
(a) a flexible open cell polymeric foam element and
(b) a binder selected from:
   (i) an hydraulic binder slurry; or
   (ii) a mixture of a pozzolan and either lime or Portland cement in the form of a slurry;
   (iii) a synthetic geopolymer precursor slurry; or
   (iv) a thermoplastic material in liquid form; which includes the steps of:
   (1) introducing the binder into the open cells of the foam element by either:
      (i) compressing the foam element to exclude air from the open cells and then releasing the compression with the foam element in contact with the binder so that the binder penetrates and becomes contained in the open cells of the foam element as it regains its shape; or
      (ii) impregnating the binder into the foam element under pressure so that the binder penetrates and becomes contained in the open cells of the foam element; and
   (2) allowing the binder to set or harden and dry to form the product.

In one embodiment, in step (1), the foam element is submerged in the hydraulic binder slurry, and while submerged, the foam element is compressed to exclude air from the open cells. The compression is then released so that the slurry penetrates and becomes contained in the open cells. In a second embodiment of the invention, in step (1), the hydraulic binder slurry is applied to a surface of the foam element prior to the foam element being compressed to exclude air from the open cells. In a third embodiment, in step (1), the hydraulic binder in dry powder form is placed on the foam element, which hydraulic binder is slurried with water, whereafter the foam element with the hydraulic binder slurry thereon is compressed to exclude air from the open cells.

In a fourth embodiment of the invention, in step (1), the foam element is compressed to exclude air from the open cells, and while compressed or as the compression is released, a hydraulic binder slurry is applied to a surface of the foam element. As the compression is released and the foam element regains its shape, the slurry penetrates and becomes contained in the open cells.

This step may be repeated.

The compression of the foam element in step (1) is carried out by passing the foam element between a first roller and a surface, for example a second roller. The hydraulic binder slurry is preferably applied to a surface of the foam element directly by at least one of the first and second rollers.

This may be achieved by providing the or each roller with a perforated surface for contacting a surface of the foam element and a hydraulic binder slurry feed arrangement for feeding the hydraulic binder slurry to the perforated surface of the or each roller for application to a surface of the foam element.

In a fifth embodiment of the method of the invention the binder is fed under pressure directly by one of the perforated rollers the binder penetrating the open cells of the foam element from one side forcing the air out of the foam element from the opposite side without the foam being compressed. Optionally this procedure may be repeated from the other side of the foam element as it is wound around a perforated roller revolving in the opposite direction to the first one and again without need of compression.

It has also been found that thermoplastic materials can be used instead of hydraulic binders in the method of the invention. Thus, the method of the invention as described above, in particular that described in the fourth and fifth embodiments of the invention, included producing a product from:
(b) a thermoplastic material

The thermoplastic material is preferably a thermoplastic composition selected from the group consisting of polystyrene, polyethylene, polypropylene, polyvinyl chloride, polyvinyl acetal, A.B.S, bitumen, and refinery bi-product, or any compatible combination, mixture or blend thereof.

In particular, the thermoplastic composition is a molten thermoplastic composition.

According to a second aspect of the invention there is provided a product comprising an open cell polymeric foam element containing a set binder as described above in the open cells. The product is preferably made by the method described above.

### BRIEF DESCRIPTION OF THE DRAWING

FIG. 1 is a schematic diagram of an embodiment of the method of the invention.

FIG. 2 is a schematic diagram of further embodiments of the method of the invention.

FIG. 3 is a schematic diagram of continuous, optionally simultaneous, pressure injection as used in the fourth embodiment of the method of the invention.

FIG. 4 is a schematic diagram of continuous, optionally sequential, pressure injection as used in the fifth embodiment of the method of the invention.

### DESCRIPTION OF EMBODIMENTS

The first aspect of the invention is a method of producing a product from a flexible open cell polymeric foam element and a binder.

The first component is thus a flexible open cell polymeric foam element.

The preferred flexible open cell polymeric foam element is made from a polyurethane foam having a density in the range of from 6 kg/m³ to 40 kg/m³, more preferably from 7 kg/m³ to 20 kg/m³ inclusive more preferably from 7 to 12 kgs/m³. A particularly suitable flexible open cell polyurethane foam is one based on the combination of a toluene diisocyanate with a polyol, water, methylene chloride as a blowing agent, stannous octoate as a catalyst, and a surfactant which determines the cell size. Toluene diisocyanate is produced as two isomers, viz. 2,4-toluene diisocyanate (2,4-TDI) and 2,6-toluene diisocyanate (2,6-TDI) and is commercially available as:
greater than or equal to 99.5% 2,4-TDI;
80% 2,4-TDI and 20% 2,6-TDI which is the most commonly used product and is referred to hereinafter as TDI (80:20);
65% 2,4-TDI and 35% 2,6-TDI; and
“crude” TDI with an unidentified isomer ratio.

An example of a composition for use in making a flexible open cell polyurethane foam is as follows:

80 parts TDI Toluene di-isocyanate and 20 parts MDI diphenylmethanediisocyanate

| | |
|---|---|
| TDI (80:20) | 578.7 |
| Durapol 3000 (a polyol) | 675 |
| Water | 46 |
| Silicone surfactant (Niax L/580) | 19.6 |
| 33 LV (catalyst) | 1.9 |
| Glycerine (crosslinker) | 3.7 |
| Methylene chloride (blowing agent) | 166 |
| Stannous octoate (catalyst) | 2.1 |
| All parts by weight | |

The result is a TDI flexible open cell medium hard polyurethane foam with a density of 10 kg/m³.

Other suitable polymeric foams include polyester foams, polyether foams, polyurethane polyester hybrid foams, and the like.

It is important that the polymeric foam element has a good “memory” so that after it has been compressed, when the compression is released, the foam element returns to substantially its original dimensions so that the binder can fill the open cells.

It is also important that the polymeric foam element has a suitable hardness as it is required to act as a carrier for the binder and act to as a re-inforcer therefor.

It is preferable that the polymeric foam cell size is not too small so that the surface area of the foam is not too great. A cell size in the range 1 to 5.mm diameter is preferred giving a composite of excellent strength at low densities.

As the polymeric foam element is flexible, the element may be post formed into a desired shape before the binder hardens. The shaping of the polymeric foam element containing the binder may take place in a mould or maybe formed between the platens of a press or the like.

Alternatively, the polymeric foam element may be shaped before it comes into contact with the binder. For example the polymeric foam element may be produced in a block and then cut to a desired shape, e.g for the production of a fielded and planed door core, a shaped roof tile, or a board with textured surfaces, before the binder is introduced, and which shape is maintained by the “memory” of the foam, after the binder has been introduced.

The second component is a choice of inorganic hydraulic binders as slurries in water binder.

The hydraulic binder is preferably selected from the group consisting of Portland cement, the alpha and beta hemi-hydrates of calcium sulphate, a calcium aluminate cement, magnesium oxychloride, and magnesium oxysulphate.

The hydraulic binder may be a Portland cement, preferably a rapid hardening Portland cement with a particle size of from 475 m²/kg or finer. The Portland cement may be mixed with up to 15% by weight of an undensified silica fume with a particle size of about 20000 m²/kg.

When the hydraulic binder is the alpha or beta hemi-hydrate of calcium sulphate, it is preferably the beta-hemi hydrate of calcium sulphate, which is preferably finely ground, having a particle size of 300 which may be either synthetic or natural. This product is also referred to as gypsum.

When the hydraulic binder is Portland cement, the hydraulic binder slurry preferably contains 35 to 55 parts by weight of water to 100 parts by weight of the Portland cement. When the hydraulic binder is the beta hemi-hydrate of calcium sulphate, the hydraulic binder slurry preferably contains from 55 to 130 parts by weight of water to 100 parts by weight of the binder.

The hydraulic binder slurry may include various optional additives as follows:
1 a polyvinyl alcohol as an auxiliary binder, introduced in the water. A suitable example is Mowiol 8/88 by Clariant.
2 An acrylic emulsion a methacrylate or a polyvinyl acetate, added in the water, which increases water resistance, toughness and flexural strength. An example is Acrylic Polymer E330 by Rohm & Haas.
3 A super plasticiser in order to reduce the water to binder ratio at a given viscosity. A suitable example is Melment F10 by Hoechst, which is a melamine formaldehyde condensate.
4 A hydrophobic agent such as a silicone masonry water repellant. A suitable example is BS 94 by Wacker which is an anhydrous silicone based on hydrogen polysiloxane. When the hydraulic binder is gypsum, it is preferably added to the gypsum in an amount of about 0.3% by weight. Another suitable hydrophobic agent, particularly for use with Portland cement is BS 1307 by Wacker which is a silicone resin siloxane mixture which is used in an amount of about 0.4% by weight.
5 A hydrate precursor or hydrogel such as Borax or an alkali silicate respectively to improve performance in fire.
6 Reinforcing fibres of a maximum length of 1 mm such as cellulose or polyamide.

The inorganic binder may also be a combination of a pozzolan and lime or Portland cement in a water slurry.

Suitable pozzolans include silica fume with a particle size in the range of from 5000 to 20000 m²/kg, ground granulated blast furnace slag with a particle size in the range of from 300 to 2000 m²/kg, and fly ash with a particle size in the range of from 300 to 2000 m²/kg, or a mixture of any two or more thereof.

As stated above, the pozzolan must be combined with either lime or Portland cement as the source of calcium hydroxide. Generally there is used 95 to 75 parts by weight of the pozzolan to 5 to 25 parts by weight of the lime or Portland cement.

The inorganic binder may also be a synthetic goepolymer precursor in water slurry. An example of a suitable geopolymer precursor is a blend of a metal oxide such as aluminium oxide or magnesium oxide with a calcium silicate, in the form of Wollastonite, the blend having a particle size of 300 mesh or finer. In this case, the geopolymer precursor is impregnated into the foam element in the form of a water slurry. Thereafter the foam element containing the slurry is dried and then post-impregnated with a compound selected from the group consisting of ammonium phosphate, phosphoric acid, or a solution of aluminium phosphate and phosphoric acid, to form the geopolymer, viz. a magnesium ammonium phosphate hexahydrate.

The retention of the hydraulic binder slurry in foam elements where the cell sizes are relatively large is a function of apparent viscosity or rheology. In order to ensure a suitable rheology, silica fume may be added to Portland cement, or suitable organic thickeners may be added to any of the hydraulic binders. Acrylic based thickener compounds are preferred.

The first step of the method of the invention is to introduce the hydraulic binder slurry into the open cells of the foam element by compressing the foam element to exclude air from the open cells and then releasing the compression with the foam element in contact with the hydraulic binder slurry so that the slurry penetrates and becomes contained in the open cells.

In one embodiment of the invention, the foam element is submerged in the hydraulic binder slurry and while submerged, the foam element is compressed, whereafter the compression is released so that the slurry penetrates and becomes contained in the open cells.

In the compression stage, the air in the open cells of the foam element is forced out of the open cells. Thereafter, when the compression is released, the foam element, having a memory, returns substantially to its original size and shape, i.e the open cells open up again, allowing the hydraulic binder to penetrate and be contained in the open cells.

It is not necessary to exclude all of the air from the open cells of the foam element. Depending on the nature of the product to be manufactured, the amount of air to be excluded from the open cells can be determined.

The compression of the foam element is preferably carried out by passing the foam element between a first roller and a surface, for example a second roller.

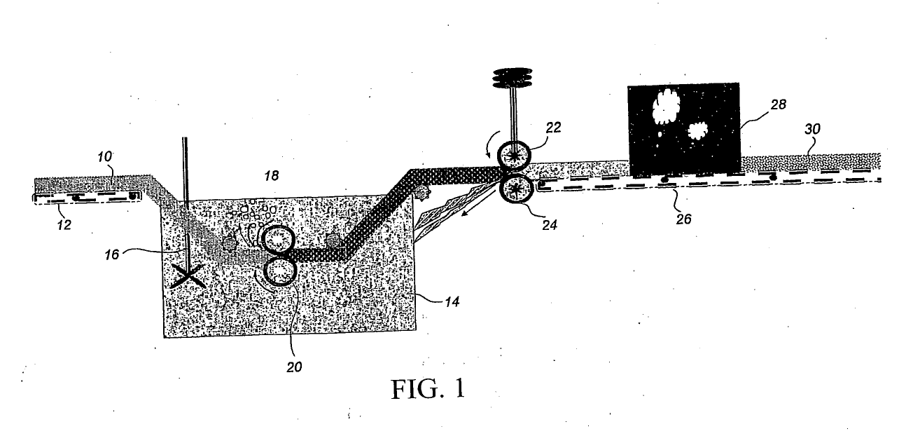

This first embodiment of the invention is illustrated in FIG. 1.

Referring to FIG. 1, a flexible open cell polymeric foam element 10, which may be either a continuous sheet, or a discrete element, which may be flat or shaped, is transported on a conveyor 12 into a slurry tank 14 containing an agitator 16. The slurry tank 14 is filled with a hydraulic binder slurry. The foam element 10 is passed between two rollers 18, 20 between which the foam element 10 is compressed. On exiting the rollers 18, 20 the foam element 10 regains its original size and shape and the hydraulic binder slurry penetrates and becomes contained in the open cells of the foam element 10. The foam element 10 now containing the hydraulic binder slurry passes out of the slurry tank 14 and is passed between two rollers 22, 24. The foam element 10 containing the hydraulic binder slurry is compressed between the rollers 22, 24 to extract some of the hydraulic binder slurry therefrom. This hydraulic binder slurry is then fed back to the slurry tank 14.

The foam element 10 now containing the desired content of hydraulic binder slurry is passed onto a conveyor 26 and then through a drier 28 in which the hydraulic binder hydrates and sets and is dried. The final product 30 then exits the drier 28.

In an alternative, before the hydraulic binder in the hydraulic binder slurry hydrates and sets, the foam element containing the hydraulic binder slurry may be formed into a desired shape. For example, the foam element containing the hydraulic binder slurry may be placed onto a mould and then conformed to a shape such as a corrugated sheet or U-section or the like.

In a second embodiment of the invention, a hydraulic binder slurry may be applied to a surface of the foam element. Then the foam element with the hydraulic binder thereon is compressed to exclude air from the open cells and then the compression is released so that the hydraulic binder slurry penetrates and becomes contained in the open cells. The compression between the rollers or perforated compression plate or plates forces penetration of the hydraulic binder slurry into the open cells of the foam element. This step may be repeated in order to ensure sufficient penetration of the hydraulic binder slurry into the open cells of the foam element. This embodiment has the advantage that weights and final product densities may be very accurately controlled in a batch production context.

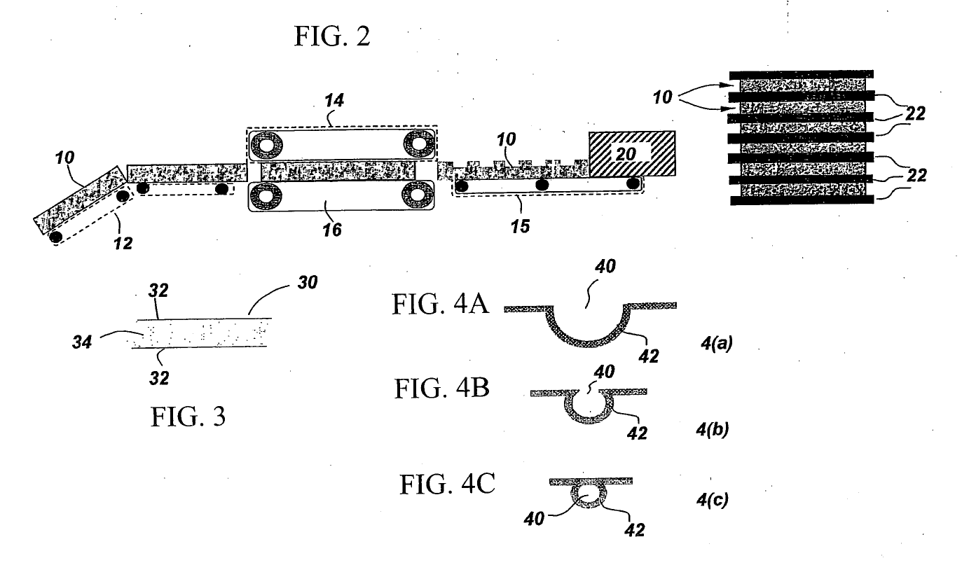

A further embodiment of the invention is illustrated in FIG. 2 which is;
(i) to impose a shape upon the foam element containing the inorganic binder slurry, and/or
(ii) to achieve a higher concentration of the inorganic binder slurry at the surfaces of the foam element when compared with the concentration of the organic binder slurry in the interior of the foam element.

In terms of the second alternative, the foam element containing the inorganic binder slurry is compressed to impose a shape upon the foam element, either on one or both sides of the foam element, which shape is retained when the inorganic binder sets.

This is illustrated schematically in FIG. 2, Referring to FIG. 2, a foam element 10 impregnated with an inorganic binder slurry is conveyed from a slurry tank (not shown) on a conveyer 12 and then between top and bottom conveyors 14, 16 respectively, the conveyor 14 being shaped as illustrated, to impose a shape upon the foam element 10. The inorganic binder impregnated in the foam element 10 must set sufficiently prior to release from the conveyors 14, 16 so that the foam element 10 retains its shape once it is moved out from between the conveyors 14, 16.

The shaped foam element 10 is then conveyed on a conveyor 18 into a drier 20, where the product is dried.

As an alternative, when the inorganic binder is for example a Portland cement, the foam element 10 may be shaped between platens 22 which are then stacked and/or clamped to allow the Portland cement to set sufficiently prior to removal of the foam elements 10 from the platens 22, e.g for a period of 12 to 24 hours.

For example, the foam elements 10 may be allowed to hydrate fully over an extended period by stacking in an open area with or without steam curing.

In the third alterative, the foam element containing the inorganic binder slurry is compressed to increase the concentration of the inorganic binder at the surfaces of the foam element relative to the concentration of the inorganic binder in the interior of the foam element.

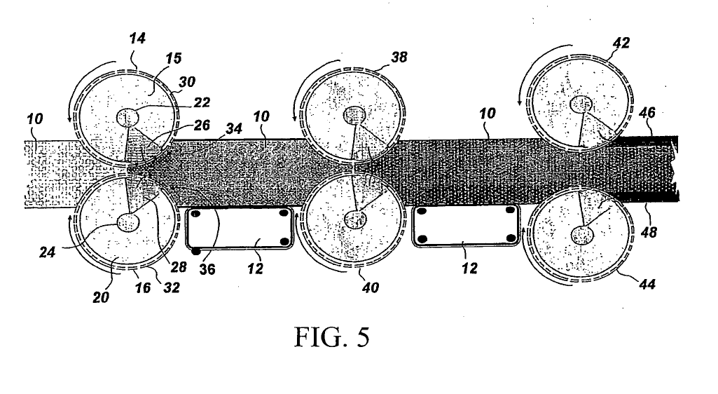

This is illustrated in FIG. 3 where there is shown a foam element 30 having a higher concentration of inorganic binder 32 close to the surfaces thereof relative to the concentration of inorganic binder 34 in the interior of the foam element 30.

For example the foam element may initially have a thickness of 20 mm which is then compressed to a final thickness of 12 mm.

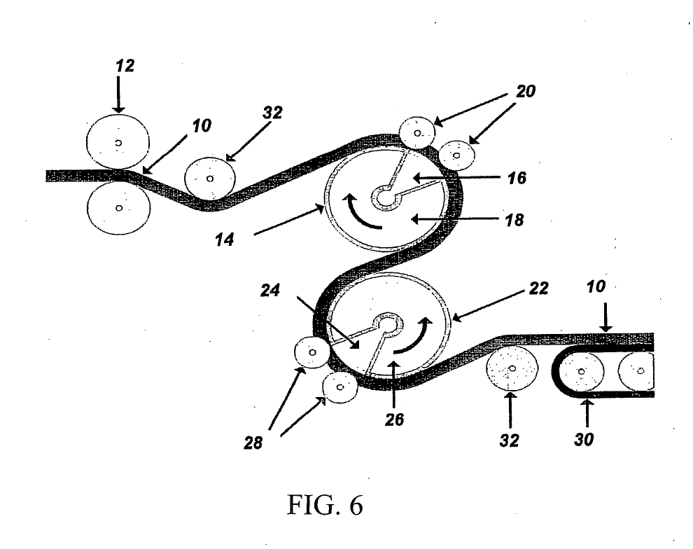

This is achieved as is illustrated schematically in FIG. 4. In FIG. 4A, there is shown an open cell 40 of a foam element containing an amount of an inorganic binder 42. In FIG. 4B the same cell 40 is illustrated when it has been partly compressed, indicating the concentration of the inorganic binder 42 in the cell. In FIG. 4C there is again illustrated the same cell 40, now with an even greater concentration of the inorganic binder 42 in the cell 40.

In this way, it is possible to produce what is effectively a stress skin component with the highest concentration of the inorganic binder being in the outer horizons of the component. This is also used for lamination.

The hydraulic binder slurry may be reinforced with thermoplastic polymers chosen from acrylates, methacrylates, vinyls or polyvinyl alcohol, or with water miscible thermosets such as oligo isocyanates such as Suprasec 1042 by Huntsman, or phenol formaldehyde resoles.

A fourth embodiment of the invention is illustrated in FIG. 5 which is;

Referring to FIG. 5, a flexible open cell polymeric foam element 10, which may be either a continuous sheet or a discrete element, which may be flat or shaped, is transported on a conveyor 12 between two rollers 14, 16 between which the foam element 10 is compressed.

The rollers 14, 16, in this embodiment, are revolving perforated hollow feed tube rollers that include solid stationary cores 18, 20, respectively. The cores 18, 20 include respective feed conduits or channels 22, 24 for conveying a hydraulic binder slurry to the rollers 14, 16 and respective feed passages 26, 28 for feeding the hydraulic binder slurry to the perforated surfaces 30, 32.

The hydraulic binder slurry then contacts the surfaces 34, 36 of the foam element 10, whilst compressed and/or as compression is released, and then penetrates and becomes contained in the open cells of the foam element 10 as compression is released on exiting the rollers 18, 20.

On exiting the rollers 18, 20 the impregnated foam element 10 regains its original size and shape. The foam element 10 now containing the hydraulic binder slurry may be passed through a second set of perforated hollow tube rollers 38, 40, where the abovementioned method may be repeated. In addition, the impregnated foam element 10 may be passed between an optional third set of hollow feed tube rollers 42, 44 which only partially compress the foam element 10 thereby resulting in partial impregnation of the outer regions of the foam element 10 to form integrated solid or semi-sold outer skins 46, 48. The foam element 10 now containing the desired content of hydraulic binder slurry can then be further treated.

A potential difficulty in using the method referred to as the first embodiment of the invention illustrated in FIG. 1 is that when water is added to a hydraulic binder, hydration immediately commences and even in a continuous process the binder slurry in a bath or container will, in a relatively short period of time, produce lumps, accumulations or granules of set or partly set hydraulic binder at different stages of the hydration process. In some cases, such as gypsum, the hydration process can be almost indefinitely retarded, but this requires added cost and at some point in the process, either the retardation must be neutralised or the hydration accelerated to overcome the retarder.

A further potential difficulty in impregnating the open cellular foam in a bath in which it is submerged is that when it is removed from the bath, the relatively high viscosity of the slurry on top of the emerging impregnated foam means that it must be removed unless the sheet exits the bath vertically. This difficulty is particularly true of sheet material.

In addition to obviating the above potential difficulties of submersion of the foam element, this fourth embodiment of the invention allows for the degree of impregnation to be accurately controlled by pressure of the binder and the speed of the feed rollers. Further, the system is self-purging, preventing the accumulation of set or semi-set hydraulic binder. Further, it makes provision for varying the reology or apparent viscosity of the slurry without process difficulty, because it is under positive pressure and is forced into the foam. It also allows for the inclusion of a heavily or totally impregnated outer layer for added strength and water resistance of the final product. The system is easy to clean and easy to maintain and the binder can be easily maintained at a specific temperature by heating the stationary solid cores of the perforated rollers.

As indicated above, there may be used instead of the hydraulic binder slurry a thermoplastic material, typically a thermoplastic composition. The thermoplastic composition, which is preferably molten for ease of processing, may be selected from the group consisting of polystyrene, polyethylene, polypropylene, polyvinyl chloride, polyvinyl acetal, A.B.S, bitumen or refinery waste.

A fifth embodiment of the method of the invention is illustrated in FIG. 6

An example of the introduction of a binder into the open cells of a foam element by impregnation under pressure will now be given.

FIG. 6 is a schematic diagram of this method of the invention. A length of an open cell polymeric foam element 10 is passed between free rolling feed rollers 12 which have a clutch controlled resistance so as to apply a tension to the open cell polymeric foam element 10. The open cell polymeric foam element 10 is pulled by a perforated feed roller 14, rotating in the direction shown. At the feed roller 14, a binder in slurry or liquid form is impregnated into the open cell polymeric foam element 10 through a feed galley 16 in an assembly 18. As the binder in slurry or liquid form is injected into one side of the open cell polymeric foam element 10, air in the open cells is exhausted from the other side of the open cell polymeric foam element 10.

Optionally, compression rollers 20 may compress the open cell polymeric foam element 10 to ensure uniform wetting and penetration of the binder.

The open cell polymeric foam element 10 now impregnated from one side is then wound around a second perforated feed roller 22, rotating in the opposite direction to the feed roller 14. The feed roller 22 includes a feed galley 24 in an assembly 26 which injects the binder in slurry or liquid form into the opposite side of the open cell polymeric foam element 10, with air again escaping from the side of the open cell polymeric foam element 10 not being impregnated.

The assembly again may include compression rollers 28 to ensure uniform wetting and penetration of the binder.

The impregnated open cell foam element 10 is then deposited onto a conveyor 30.

Adjustable tension rollers 32 control the tension in the open cell polymeric foam element 10 as well as the area of surface contact with the perforated feed rollers 14 and 22.

The binder impregnated into the open cell polymeric foam element 10 is then allowed to set to form the finished product.

As an alternative, the binder may be impregnated under pressure into the open cells of the foam element from one side thereof only, the binder penetrating through the entire thickness of the foam element

In another embodiment a binder precursor may be impregnated into the open cells of the foam element from one side of the element by a first feed roller followed by the impregnation into the foam element of a reactant to the binder precursor from the other side of the foam element by a second or sequential roller.

As indicated in the previous embodiments, before the binder sets, the foam element containing the binder may be formed into a desired shape.

In another embodiment of the invention, when the binder is a hydraulic binder slurry, the hydraulic binder slurry may be foamed by any method known in the art, i.e. the use of a pre-formed foam on the use of a foaming agent that foams in situ to give a low density hydraulic binder slurry.

The resulting product has a low density and yet a high thermal insulation and this is suitable for all thermal insulation applications, particularly the insulation of buildings.

Examples of products which may be produced by the method of the invention include the following:

Gypsum Containing Products

A product moulded on both sides, such as the core of a fielded and planed or multi panelled door, with a dry density in the range of from 250 to 400 kg/m³ inclusive.

A product moulded to have a texture or pattern on one surface, such as an acoustic ceiling tile, with a dry density in the range of from 200 to 300 kg/m³ inclusive.

Ceiling boards, wall boards and wall cores, particularly wall boards reinforced with an acrylic to conform to the ASTM performance standards for wall boards without paper liners, with a dry density in the range of from 400 to 600 kg/m³ inclusive, or more preferably laminated with paper on both sides by a thermoplastic polymer reinforced gypsum slurry.

Thermal insulation panels with a dry density in the range of from 100 to 175 kg/m³ inclusive and an R value of 3.2.

Portland Cement Products

Siding where the foam element has been shaped to the requisite profile to produce a product with a dry density of about 800 kg/m³, which may then receive a pure acrylic pigmented overcoat.

Splash backs with a density of about 900 kg/m³ and a typical thickness of about 12 mm.

Corrugated roof sheeting where the form element containing the hydraulic binder slurry has been shaped over a former to provide a corrugated profile, the product having a dry density of about 1200 kg/m³.

A roof tile with a dry density in the range of from 1200 to 1500 kg/m³.

A U-section gutter, having a thickness of 10 mm and a dry density of about 1400 kg/m³.

Another product which may be produced by the method of the invention is lightweight aggregate, formed from chipped foam particles or granules which may then be bound together by a hydraulic binder before or after setting, or by another binder after setting, and used as a castable or sprayable composition.

The foam element may be formed into particles or granules before coming into contact with the hydraulic binder slurry. Alternatively the product may be broken up after the hydraulic binder has set to give particles or granules.

The density of the product is controlled by the following variables:
the cell size of the polymeric foam element;
the water to hydraulic binder proportion by weight in excess of that required for full hydration of the hydraulic binder; and
the amount of the hydraulic binder slurry removed from the saturated polymeric foam element during the method.

Densities of from 100 to 1500 kg/m³ are achievable with great accuracy by the method of the invention.

It is also to be noted that because the polymeric foam element has a uniformity of cell distribution, the resulting product is also uniform.

In addition, dense surface skins of hydraulic binder may easily be incorporated into a product before setting of the hydraulic binder.

The method of the invention has various advantages. Firstly, it utilises simple equipment which thus has cost implications. The method is also energy efficient. The method allows density control of the finished product over a wide range. Using the method of the invention it is possible to produce a wide variety of finished products, with a variety of shapes.

A particular advantage unique over other forms of foamed inorganic binders is the peel strength, or resistance to delamination, of laminated foam due to the penetration of the adhesive system to a requisite depth.

The method permits the production of products containing no lignocellulosic or other carrier fibres with their associated disadvantages.

Examples of the invention will now be given.

### EXAMPLE 1

An acoustic ceiling tile is made by the following method:

There is provided a 20 mm thick 10 kg/m³ density open cell flexible TDI polyurethane foam element.

There is produced a hydraulic binder slurry containing:

| | |
|---|---|
| Beta hemihydrate natural gypsum fine grind | 1200 |
| 2% solution of Mowiol 8/88 by Clariant - polyvinyl | 800 |
| alcohol in water solution | |
| Melment F10 super plasticiser by Hoechst | 10 |
| Wacker BS15 potassium methyl siliconate | 20 |
| All parts by weight | |

The foam element is passed into a slurry tank containing the hydraulic binder slurry composition set above and is compressed between two rollers. On release of the compression, the hydraulic binder slurry penetrates and becomes contained in the open cells of the foam element.

The foam element containing the hydraulic binder slurry is passed out of the slurry tank and is rolled between two rollers to extract certain of the hydraulic binder slurry. The foam element containing the desired quantity of hydraulic binder slurry is then passed through a drier where the hydraulic binder sets and the product dries. Thereafter the product is cut to size to produce a ceiling tile measuring 600×600×20 mm with a dry density of 250 kg/m³.

### EXAMPLE 2

A building board is made by the following method:

There is provided an 8 mm thick 14 kg/m³ density flexible open cell TDI polyurethane foam element.

There is produced a hydraulic binder slurry containing:

| | |
|---|---|
| Rapid hardening Portland cement | 900 |
| Silica fume undensified | 100 |
| Water | 420 |
| Acrylic emulsion | 60 |
| Melment F10 super plasticiser | 10 |
| Wacker BS1307 silicone base | 6 |
| All parts by weight | |

The foam element is passed into a slurry tank containing the hydraulic binder slurry composition described above. The foam element is compressed between two rollers in the slurry tank. On release of the compression, the hydraulic binder slurry penetrates and becomes contained in the open cells of the foam element.

The foam element containing the hydraulic binder slurry is passed out of the slurry tank. The Portland cement is allowed to hydrate and set, whereafter the product is dried to produce an 8 mm thick building board with a density of 900 kg/m³. The board is easy to cut and nail, can be machined, is resistant to freeze/thaw and is cost effective.

1-17. (canceled)

18. A method for manufacturing a product which includes the steps of:
a) engaging an open cell polymeric foam element with at least a first perforated roller;
b) feeding a binder through the first roller;
c) impregnating the binder into the foam element so that the binder penetrates and becomes contained in the open cells of the foam element; and
d) allowing the binder to set to form the product.

19. A method according to claim 18 wherein the foam element includes a flexible open cell polyurethane foam in the density range 7 to 20 kg/m³.

20. A method according to claim 18 wherein the first roller includes a perforated surface through which the binder is delivered.

21. A method according to claim 20 wherein the first roller includes a feed passage where through the binder moves to the perforated surface.

22. A method according to claim 18 wherein the binder is selected from:
i) an hydraulic binder slurry;
ii) a mixture of a pozzolan and either lime or Portland cement in the form of a slurry;
iii) a synthetic geopolymer precursor slurry; and
iv) a thermoplastic material in liquid form.
v)

23. A method according to claim 22 wherein the hydraulic binder slurry is selected from:
i) alpha or beta hemihydrates of calcium sulphates;
ii) Portland cement;
iii) calcium aluminate;
iv) a pozzolan with lime or with Portland cement;
v) magnesium oxichloride; and
vi) magnesium oxisulphate.

24. A method according to claim 18 which includes the step of compressing the foam element.

25. A method according to claim 18 which includes the step of shaping the foam element by molding, pressing or cutting.

26. A method according to claim 18 which includes the step of engaging the foam element with a second perforated roller.

27. A method according to claim 18 which includes the step of engaging the foam element with a first set of rollers consisting of the first and second rollers and at least a second set of rollers.

28. A method according to claim 18 which includes the step of drying the binder impregnated foam element in a drier.
